(19) United States
(12) Patent Application Publication
(10) Pub. No.: US 2016/0130997 A1
(43) Pub. Date: May 12, 2016

(54) METHOD FOR COATING CATALYST ON DIESEL PARTICULATE FILTER

(71) Applicants: Hyundai Motor Company, Seoul (KR); Kia Motors Corp., Seoul (KR)

(72) Inventor: Choong Il KWON, Gunpo-si (KR)

(73) Assignees: Hyundai Motor Company, Seoul (KR); Kia Motors Corp,, Seoul (KR)

(21) Appl. No.: 14/688,320

(22) Filed: Apr. 16, 2015

(30) Foreign Application Priority Data
Nov. 11, 2014 (KR) 10-2014-0156254

(51) Int. Cl. F01N 3/035; B01J 35/04; B01J 35/10; B01J 37/02

(52) U.S. Cl. CPC F01N 3/035; B01J 37/024; B01J 35/04; B01J 35/1076

(57) ABSTRACT

A method for coating catalyst on a diesel particulate filter includes the steps of, preparing a filter main body by using a substance through which a plurality of pores are formed. coating firstly a reduction catalytic agent on the filter main body by immersing the filter main body into a wash coat solution containing the reduction catalytic agent. coating secondly the reduction catalytic agent on a region of the filter main body where a distribution of the firstly coated reduction catalytic agent is relatively low by providing absorption pressure to the other channel opposite to the selected one channel while supplying the wash coat solution containing the reduction catalytic agent to one channel that is selected from the inlet channel and the outlet channel of the filter main body that has been coated firstly.

### CROSS-REFERENCE(S) TO RELATED APPLICATION

The present application claims priority of Korean Patent Application Number 10-2014-0156254 filed on Nov. 11, 2014, the entire contents of which application are incorporated herein for all purposes by this reference.

### BACKGROUND

1. Field of the Invention

The present invention relates to a method for coating catalyst on a diesel particulate filer, and more particularly, to a method for coating catalyst on a diesel particulate filter in which the catalyst is coated evenly through pores of a filter main body.

2. Description of Related Art

Generally, a vehicle of a diesel engine is excellent in terms of fuel ratio and output and further a generation amount of carbon monoxide or hydrocarbon is smaller, comparing to a vehicle of a gasoline engine. However, a vehicle of a diesel engine has more amount of generations of Particulate Material (PM) of pollute material and nitrogen oxide (NOx), comparing to a vehicle of a gasoline engine.

Accordingly, according to a related art, the devices of Diesel Oxidation Cataylyst (DOC), Diesel Particulate Filter (DPF), reduction agent injector, and Selective Catalytic Reduction (SCR) or Lean NOx Trap (LNT) are installed on an exhaust line of an exhaust gas purifier adapted to a general vehicle of a diesel engine.

The pollute substance contained in an exhaust gas is removed while the exhaust gas discharged from a diesel engine passes sequentially through the devices of Diesel Oxidation Catalyst, Diesel Particulate Filter and Selective Catalytic Reduction.

That is, The Diesel Oxidation Catalyst (DOC) oxides carbon monoxide and hydrocarbon contained in the exhaust gas into carbon dioxide, the Diesel Particulate Filter (DPF) collects particulate matter contained in an exhaust gas, and the Selective Catalytic Reduction (SCR) adsorbs nitrogen oxide contained in an exhaust gas by using a reduction agent injected from a reduction agent injector or reduces the nitrogen oxide into nitrogen gas.

Meanwhile, the Selective Catalytic Reduction device needs to have a relatively large volume so as to reduce sufficiently the nitrogen oxide.

Accordingly, cost increases due to a carrier or a carrier housing for the SCR device and when the SCR device is installed on an underfloor at a bottom side of a vehicle, a whole purification rate of nitrogen oxide may be decreased since a temperature of an exhaust gas is lowered.

Therefore, recently a technology has been proposed and used, for coating a reduction catalytic agent on a filter so as to perform a function of a selective reduction catalyst on a diesel particulate filter. For example, in a related art, entitled “S-DPF and exhaust system using the same”, a technology has been disclosed, in which a Cu-zeolite catalyst coating layer is formed at an inner side of an inlet channel of a filter, a Fe-zeolite catalyst coating layer is formed a front of an inner side of an outlet channel and a oxidation catalyst coating layer is formed on a rear end of Fe-zeolite catalyst coating layer.

Specially, S-DPF requests simultaneously a function for collecting the particulate matter as the function of DPF and a function for adsorbing nitrogen oxide and purifying it as the function of SCR.

However, the reduction catalytic agent is coated at pores inside a filter and exists within the filter in the technology for coating a reduction catalytic agent on a diesel particulate filter and thus a high porous filter needs to be used so as for a large amount of the reduction catalytic agent to be existed within the filter. Here, there are a many empty spaces (pores) in the high porous filter and further the pores are formed unevenly so that it is difficult to coat evenly the reduction catalytic agent, thereby decreasing a collection ability of particulate matter and increasing a Particle Number (PN) discharge.

On the contrary, in a case where low porous filter is used to improve the function of collecting PM and PN, the amount of reduction catalytic agent is small and thus the function of adsorbing nitrogen oxide and purifying it is lowered.

Accordingly, the inventor of the present application has proposed a technology that even if a high porous filter is used, the distribution of pores is kept evenly while maintaining the sizes thereof to be small after coating the reduction catalytic agent on the filter.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for coating catalyst on a diesel particulate filter, in which the distribution of pores is kept evenly within a filter while maintaining the sizes of the pores to be small after coating a reduction catalytic agent on the filter when a large amount of reduction catalytic agent is coated by using a high porous filter.

In one aspect, a method for coating catalyst on a diesel particulate filter may include the steps of, preparing a filter main body by using a substance through which a plurality of pores are formed so as to filter an exhaust gas wherein a plurality of inlet channels each of which is opened to an introduction direction of an exhaust gas and a plurality of outlet channels each of which is opened to a discharging direction of the exhaust gas are arranged alternately.

coating firstly a reduction catalytic agent on the filter main body by immersing the filter main body into a wash coat solution containing the reduction catalytic agent.

coating secondly the reduction catalytic agent on a region of the filter main body where a distribution of the firstly coated reduction catalytic agent is relatively low by providing absorption pressure to the other channel opposite to the selected one channel while supplying the wash coat solution containing the reduction catalytic agent to one channel that is selected from the inlet channel and the outlet channel of the filter main body that has been coated firstly,

wherein a total volume of the pores the size of which are 20 μm or less among the pores existing on the filter main body after coating the reduction catalytic agent is greater than that of the pores the size of which are 20 μm or less among the pores existing on the filter main body before coating the reduction catalytic agent, and wherein an average size of pores existing on the filter main body after the second coating step is 10-20 μm.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a configuration of a S-DPF manufactured according to an exemplary embodiment of the present invention.

FIG. 2A, FIG. 2B. FIG. 2C, FIG. 2D, and FIG. 2E are views illustrating a method for coating catalyst on a diesel particulate filter according to an exemplary embodiment of the present invention.

FIG. 3A is a scanning electron microscopic picture of S-DPF according to a comparison embodiment.

FIG. 3B is a scanning electron microscopic picture of S-DPF according to an exemplary embodiment of the present invention.

FIG. 4 is a graph comparing Particle Number (PM) of S-DPE according to a comparison embodiment and a present embodiment.

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a method for coating catalyst on a diesel particulate filter according to exemplary embodiments of the present invention will be described with reference to the accompanying drawings.

Firstly, a configuration of a diesel particulate filter on which a reduction catalytic agent is coated, which is manufactured according to an exemplary embodiment of the present invention, will be described.

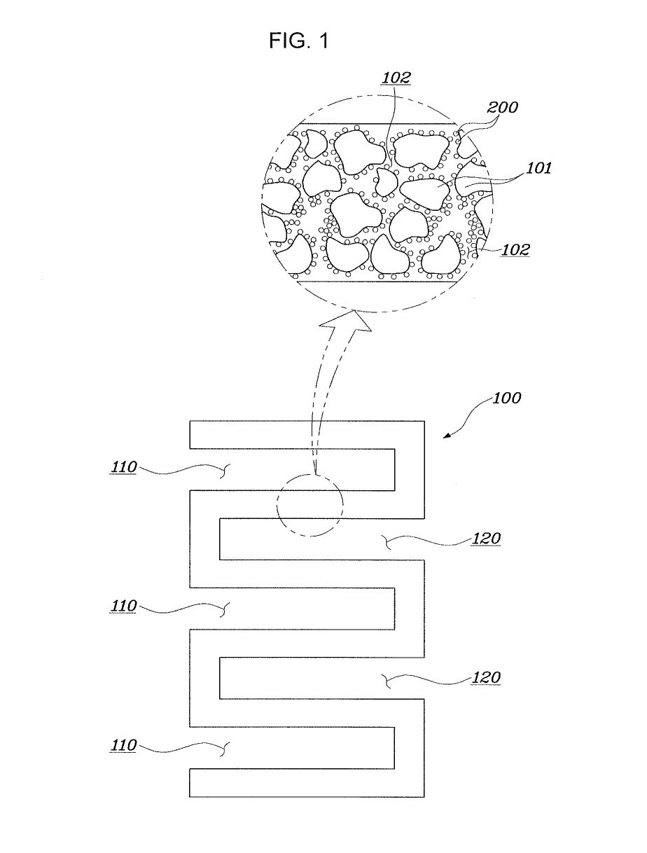

FIG. 1 is a view illustrating a configuration of a S-DPF manufactured according to an exemplary embodiment of the present invention.

As shown in FIG. 1, a diesel particulate filter on which a reduction catalytic agent is coated, which is manufactured according to a method for coating catalyst on a diesel particulate filer (hereinafter, referred to as S-DPF) is a means for collecting Particulate Material (PM) contained in an exhaust gas and at the same time purifying nitrogen oxide contained in the exhaust gas by adsorbing the nitrogen oxide and reducing it.

S-DPF includes a filter main body 100 consisting mainly of a carrier 101 through which pores 102 are formed and maintaining a shape thereof, and a reduction catalytic agent 200 coated into the pore 102 of the filter main body 100.

At this time, the filter main body 100 has several channels formed from a front part to a rear part thereof and the channels are classified as an inlet channel 110 and an outlet channel 120.

The inlet channel 110 and the outlet channel 120 are arranged adjacently and alternately. In more detail, an inlet in a front surface direction of the inlet channel 110 is opened, through which an exhaust gas is introduced, and an outlet thereof is closed by a wall formed with the filter main body 100, that is, the carrier 101. Meanwhile, an inlet of the outlet channel 120 is closed by a wall formed with the carrier 101 and an outlet thereof is opened. As a result, an exhaust gas introduced through the inlet of the inlet channel 110 is discharged to the outlet of the outlet channel 120 through the wall formed with the filter main body 100, that is, the carrier 101.

Meanwhile, a space is formed between the carriers 101 forming the filter main body 100 and thus pores 102 are formed in the filter main body 100. Accordingly, a sufficient amount of a reduction catalytic agent 200 to be coated on the main filter body 100 is maintained and thus a purification performance of nitrogen oxide due to adsorption thereof can be maintained to a desired level.

At this time, the reduction catalytic agent 200 contains Cu-zeolite, Fe-zeolite or the like. Specially, the particle sizes of the reduction catalytic agent 200 may be smaller than those of the pores formed through the filter main body 100. As a result, the reduction catalytic agent 200 enters into the pore 102 of a space between the carriers 101 forming the filter main body 100 and adheres on a surface of the carrier 101 to be coated therewith. Here, an average size of the pore 102 of the filter main body 100 may be 10-20 μm. The reason why the average size of the pore 102 of the filter main body 100 is maintained as 10-20 μm is as follows. When the size of the pore 102 is smaller than 10 μm, the particles contained in an exhaust gas, that is, the small particles corresponding to the PN exhaust regulation cannot pass through the pore and thus is accumulated on a top part of the filter thereby to cause an abrupt pressure increasing, and further the accumulation of the particles on the top part of the filter prevents gas component of nitrogen oxide NOx from being in contact with the reduction catalytic agent 200. Further, when the size of the pore is greater than 30 μm, the smaller particles passes through the pore 102 and thus the particle number that is discharged is increased, thereby exceeding to the exhaust regulation.

Further, a total volume of the pores 102 the size of which are 20 μm or less among the pores 102 existing on the filter main body 100 after coating the reduction catalytic agent 200 may be greater than that of the pores 102 the size of which are 20 μm or less among the pores 102 existing on the filter main body 100 before coating the reduction catalytic agent 200.

Next, a method for preparing S-DPF to have the above configuration will be described referring to the drawings.

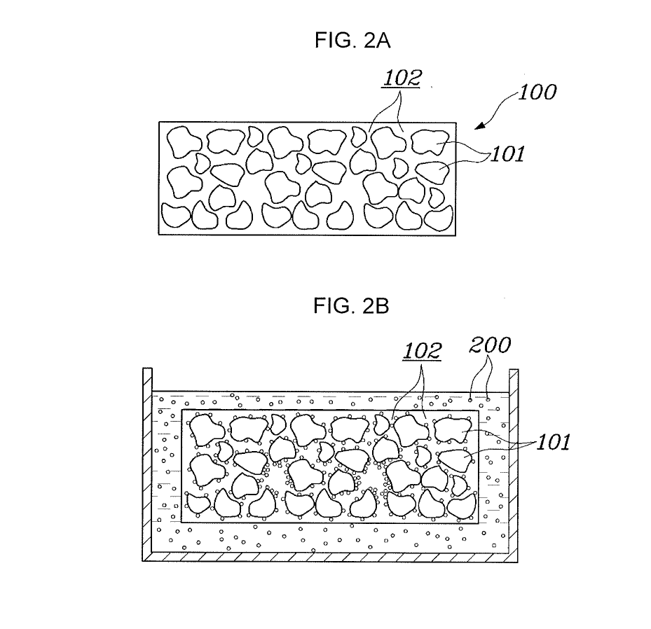

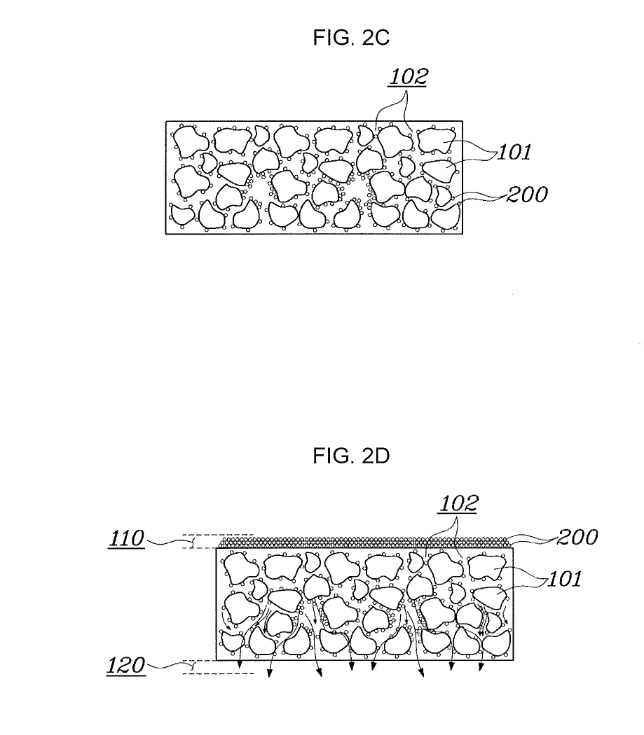

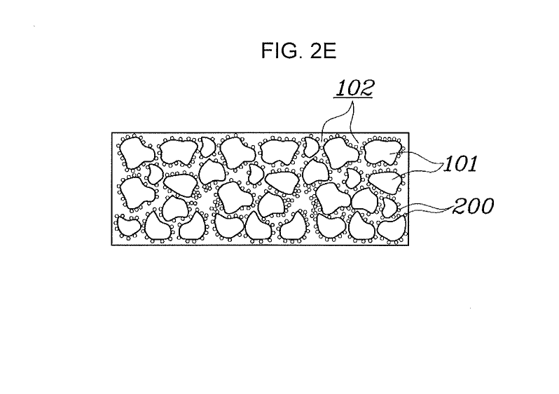

FIG. 2A-2E are views illustrating a method for coating catalyst on a diesel particulate filter according to an exemplary embodiment of the present invention.

Firstly, as shown in FIG. 2A, a filter main body 100 having a porosity rate of 58% or more is prepared (Preparing step). At this time, the filter main body 100 is prepared as a general DPF shape. For example, the filter main body 100 is formed with carriers 101 through which pores 102 are formed wherein several inlet channels 110 and outlet channels 120 are formed to be arranged adjacently and alternately.

When the filter main body 100 is prepared as described above, as shown in FIG. 2B, the prepared filter main body 100 is immersed into an immersion bath receiving a wash coat solution that contains a reduction catalytic agent 200 to coat firstly the reduction catalytic agent 200 on the filter main body (first coating step). In this process, the reduction catalytic agent 200 is adhered to the carrier 101 of the filter main body 100 and coated thereon while the wash coat solution containing the reduction catalytic agent 200 is introduced into the pore 102 of the filter main body 100.

After that, the filter main body 100 is brought up from the immersion bath under this state and then dried. A part of the reduction catalytic agent 200 is filled into the pore 102 of the filter main body 100 that has gone through the first coating step. However, the size and distribution of the pores 102 of the main filter body that is coated with the reduction catalytic agent 200 in the first coating step are uneven, as shown in FIG. 2C.

The filter main body 100 that is completed with the first coating step is coated secondly with the reduction catalytic agent 200.

In a second coating step the wash coat solution containing the reduction catalytic agent 200 is supplied to a selected one channel of the inlet channel 110 and the outlet channel 120 of the filter main body 100 in an uneven state of the size and distribution of the pores 102 and at the same time absorption pressure is provided to the other channel opposite to the selected channel (second coating step). For example, as shown in FIG. 2D, the absorption pressure is provided to the outlet channel 120 while supplying the wash coat solution containing the reduction catalytic agent 200 to the inlet channel 110. As a result, the wash coat solution containing the reduction catalytic agent 200 passes through mainly the pore of relatively larger size in which small back pressure is formed and the reduction catalytic agent 200 is filled into the pore of a larger size.

As shown in FIG. 2E, the reduction catalytic agent 200 is distributed evenly and the size of the pore 102 is kept at an even level in the filter main body 100 that is completed with the second coating step.

Specially, the second coating step may be performed repeatedly at least two times or more so as to maintain the size of the pore 102 as a desired level, for example, an average size of 10-20 μm. By performing the second coating step repeatedly the wash coat solution containing the reduction catalytic agent 200 passes through mainly every times the pore 102 of a relatively larger size in which small back pressure is formed and thus the size of the pore can be standardized downward. However, in a case where the second coating step is performed repeated several times, a step of drying the filter main body 100 may be performed alternately with a coating step.

A total volume of the pores 102 the size of which are 20 μm or less among the pores 102 existing on the filter main body 100 that is completed with the second coating step is maintained to be greater than that of the pores 102 the size of which are 20 μm or less among the pores 102 existing on the filter main body 100 that is prepared in the preparing step.

Hereinafter, a comparison of a comparison embodiment and present embodiment will be made.

According to the comparison embodiment S-DPF is coated with a reduction catalytic agent by using a general technology according to a related art. In other words, in the comparison embodiment a main filter body is prepared and then is immersed into an immersion bath receiving a wash coat solution that contains a general reduction catalytic agent thereby to prepare S-DPF to be coated with the reduction catalytic agent, which is the same state where the first coating step of the present invention is completed.

According to the present embodiment S-DPF is coated with a reduction catalytic agent by using a method for coating catalyst on a diesel particulate filter according to an exemplary embodiment of the present invention. In other words, in the present embodiment a filter main body is prepared and then is immersed into an immersion bath receiving a wash coat solution that contains a general reduction catalytic agent thereby to be coated firstly with the reduction catalytic agent and then dried. When the drying is completed, the wash coat solution containing the reduction catalytic agent is supplied to an inlet channel of the filter main body and at the same time absorption pressure is produced to an outlet channel thereby to prepare S-DPF to be coated secondly with the reduction catalytic agent.

Scanning Electron Microscopic pictures of S-DPF were taken, which is prepared according to the comparison embodiment and the present embodiment as described above.

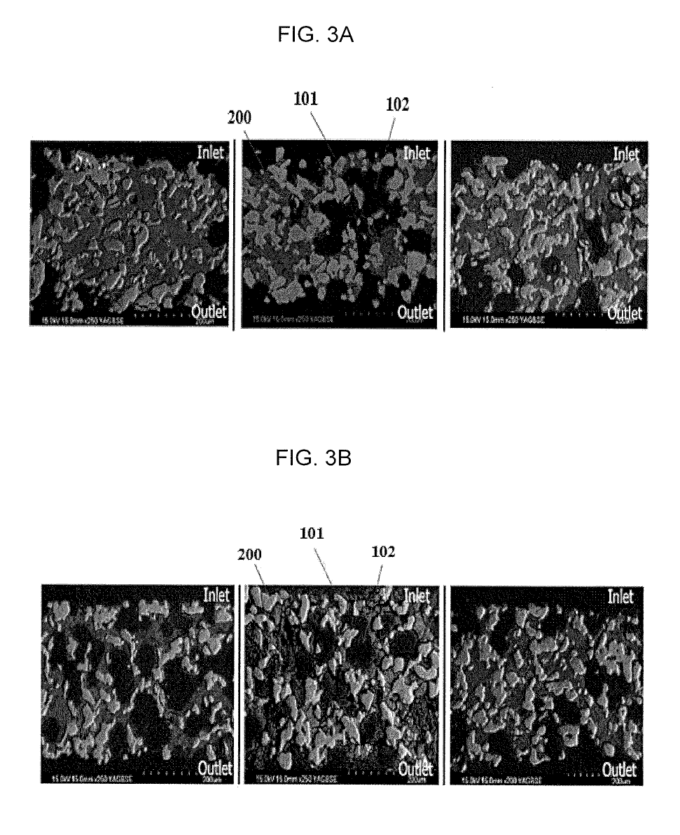

FIG. 3A is a scanning electron microscopic picture of S-DPF according to a comparison embodiment and FIG. 3B is a scanning electron microscopic picture of S-DPF according to the exemplary embodiment of the present invention. As shown in FIG. 3A, it is confirmed that the reduction catalytic agent 200 is distributed unevenly and the size of the pore 102 is uneven in S-DPF according to the comparison embodiment. On the contrary, as shown in FIG. 3B, it is confirmed that the reduction catalytic agent 200 is distributed evenly and the size of the pore 102 is even.

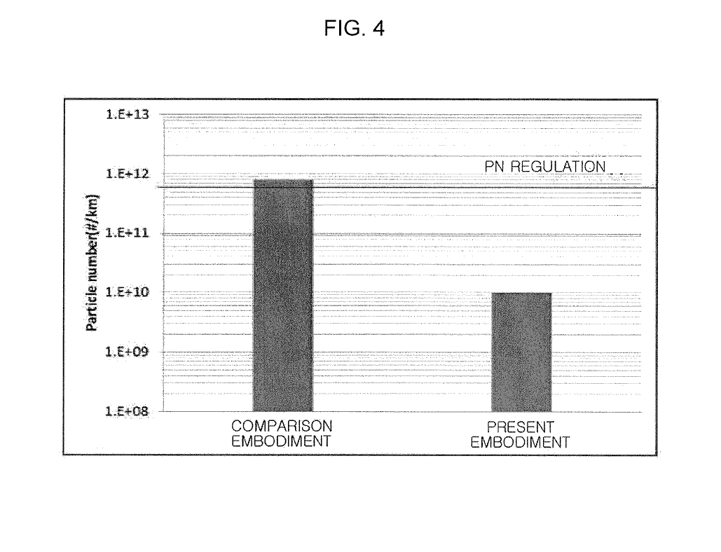

FIG. 4 is a graph comparing Particle Number (PM) of S-DPE according to a comparison embodiment and a present embodiment. As shown in FIG. 4, it is confirmed that the comparison embodiment does not satisfy PN regulation of EURO 6 standard and on the contrary the present embodiment satisfies sufficiently PN regulation of EURO standard.

Accordingly, it is confirmed that a large amount of the reduction catalytic agent is distributed evenly on S-DPF prepared according to the present embodiment and the size of the pore is formed to be even and smaller so that PM is filtered to a level to satisfy sufficiently PN regulation of EURO 6 standard while the exhaust gas passes through and at the same time adsorption and purification effects of nitrogen oxide can be improved by the reduction catalytic agent.

According to an exemplary embodiment of the present invention, a reduction catalytic agent is coated on a filter main body of high porosity in stages and thus a large amount of the reduction catalytic agent is coated thereby to maintain the size of the pore to be smaller and the distribution of the pore to be even.

Accordingly, the performance of adsorbing nitrogen oxide and purifying it by the reduction catalytic agent can be maintained to be excellent and a function of collecting PM and PN can be improved.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for coating a catalyst on a diesel particulate filter comprising:
preparing a filter main body by using a substance through which a plurality of pores are formed to filter an exhaust gas wherein a plurality of inlet channels each of which is opened to an introduction direction of the exhaust gas and a plurality of outlet channels each of which is opened to a discharging direction of the exhaust gas are arranged alternately;
coating firstly a reduction catalytic agent on the filter main body by immersing the filter main body into a wash coat solution containing the reduction catalytic agent; and
coating secondly the reduction catalytic agent on a region of the filter main body where a distribution of a firstly coated reduction catalytic agent is relatively low by providing absorption pressure to another channel opposite to a selected one channel while supplying the wash coat solution containing the reduction catalytic agent to one channel that is selected from the inlet channel and the outlet channel of the filter main body that has been coated firstly,
wherein a total volume of the pores the size of which are 20 μm or less among the pores existing on the filter main body after coating the reduction catalytic agent is greater than that of the pores the size of which are 20 μm or less among the pores existing on the filter main body before coating the reduction catalytic agent, and wherein an average size of pores existing on the filter main body after the second coating step is 10-20 μm.

2. The method for coating the catalyst on the diesel particulate filter of claim 1, wherein the filter main body prepared in the step of preparing the filter main body has a porosity rate of 58% or more.

3. The method for coating the catalyst on the diesel particulate filter of claim 1, wherein the reduction catalytic agent is coated into a part of pores formed through the filter main body in the first coating step, and the reduction catalytic agent is coated into a part of the pores, which is disposed at a region where back pressure is relatively small, by allowing the wash coat solution containing the reduction catalytic agent to pass through the pores in the second coating step.

4. The method for coating the catalyst on the diesel particulate filter of claim 1, wherein the reduction catalytic agent that is used in the first and second coating steps has particles of sizes smaller than those of the pores formed through the filter main body.

5. The method for coating the catalyst on the diesel particulate filter of claim 1, wherein the second coatings step is performed repeatedly at least two times.
